(19) United States
(12) Patent Application Publication
(10) Pub. No.: US 2013/0050287 A1
(43) Pub. Date: Feb. 28, 2013

(54) DISPLAY

(71) Applicants: Jeff Baker, Orlando, FL (US); Paul van der Pol, Winter Garden, FL (US)

(72) Inventors: Jeff Baker, Orlando, FL (US); Paul van der Pol, Winter Garden, FL (US)

(21) Appl. No.: 13/582,560

(22) PCT Filed: Mar. 3, 2011
(86) PCT No.: PCT/US11/26976

§ 371 Date: Nov. 14, 2012

Related U.S. Application Data
(60) Provisional application No. 61/310,081, filed on Mar. 3, 2010.

(51) Int. Cl. G09G 5/10; F21V 8/00

(52) U.S. Cl. 345/690; 362/606

(57) ABSTRACT

A display device, including: one or more layers of material having a light transmission region, a unit of information to be highlighted, and a light blocking region; and a backlight unit having a planar waveguide body, a light source configured to direct light into the waveguide body, and at least one light director associated with a portion of the waveguide body so as to direct light transversely to a plane of the waveguide body. The directed light travels through the light transmission region, and the directed light is directed toward the unit of information to be highlighted.

### RELATED APPLICATIONS

This application claims priority to U.S. Ser. No. 61/310,081, filed Mar. 3, 2010, which is incorporated herein in its entirety.

### FIELD OF THE INVENTION

The present invention is related displays. In particular, this invention relates to portable displays that incorporate backlighting to highlight aspects of the display.

### BACKGROUND OF THE INVENTION

Conveying information to educate or advertise can be accomplished by displays that employ any number of techniques to catch and maintain a reader's attention. Often these displays incorporate eye-catching graphics as part, or all, of the information. Some displays incorporate lighting effects in one form or another. However, that which catches a reader's attention is ever changing, as is the technology available for such displays. As a result, there remains a demand for improvements in the art.

### BRIEF DESCRIPTION OF THE INVENTION

An embodiment of the invention is directed toward a display device, including: one or more layers of material having a light transmission region, a unit of information to be highlighted, and a light blocking region; and a backlight unit having a flexible, planar waveguide body, a light source configured to direct light into the waveguide body, and at least one light director associated with a portion of the waveguide body so as to direct light transversely to a plane of the waveguide body. The directed light travels through the light transmission region, and the directed light is directed toward the unit of information to be highlighted.

Another embodiment of the invention is directed toward a display device, including one or more layers of material having a light transmission region, a unit of information to be backlit, and a light blocking region; a backlight unit having a flexible, planar waveguide body, a light source configured to direct light into the waveguide body, and at least one light director associated with a portion of the waveguide body so as to direct light transversely to a plane of the waveguide body; and a processor having a computer program module that controls illumination of the backlight unit according to a predetermined pattern. The directed light travels through the light transmission region, and the directed light is directed toward the unit of information to be highlighted.

Another embodiment of the invention is directed to a method for displaying information. The method includes: providing a display device, and illuminating the backlight unit and associated unit of information to be backlit according to a predetermined pattern. The display device includes: one or more layers of material having a light transmission region, a unit of information to be highlighted, and a light blocking region; a backlight unit having a flexible, planar waveguide body, a light source configured to direct light into the waveguide body, and at least one light director associated with a portion of the waveguide body so as to direct light transversely to a plane of the waveguide body. The directed light travels through the light transmission region, and the directed light is directed toward the unit of information to be highlighted.

Another embodiment of the invention is directed toward a display device, including: a translucent information layer substrate; information on the translucent information layer substrate, including at least one unit of information to be highlighted; a structural layer; a light blocking layer including at least one light blocking layer opening that aligns with the at least one unit of information to be highlighted; and a backlight system between the structural layer and the light blocking layer including at least one backlight unit and a power supply. Each backlight unit includes a flexible, planar waveguide body, a light source mounted on the waveguide body, and at least one light director associated with a portion of the waveguide body so as to direct light transversely to a plane of the waveguide body and toward the at least one light blocking layer opening.

Another embodiment of the invention is directed toward a display device that includes: a structural layer; a light blocking layer including at least one light blocking layer opening; a translucent information layer substrate between the structural layer and the light blocking layer, including a unit of information to be highlighted, wherein the unit of information aligns with the at least one light blocking layer opening; and a backlight system between the structural layer and the translucent information layer substrate including at least one backlight unit and a power supply. Each backlight unit includes a flexible, planar waveguide body, a light source mounted on the waveguide body, and a light director that directs light transverse to a plane of the waveguide body, wherein the light director is associated with a portion of the waveguide body that aligns with the at least one light blocking layer opening.

Another embodiment of the invention is directed toward a method for displaying information, including: illuminating a waveguide using a light source; directing at least one unit of highlighting light from the waveguide using at least one light director in a shape of a corresponding at least one unit information to be highlighted; blocking any light emanating from the waveguide other than the at least one unit of highlighting light directed by the at least one light director by interposing a light blocking layer between the waveguide and information not to be highlighted, wherein the light blocking layer comprises at least one hole in the shape of the at least one unit of information to be highlighted, and wherein the at least one light director, at least one light blocking layer hole, and at least one unit of information to be highlighted align; passing the at least one unit of highlighting light through a translucent information substrate and into the at least one unit of information to be highlighted, which is disposed thereon, together with the information not to be highlighted; and supporting the waveguide and the light blocking layer between a support layer and the translucent information substrate.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a top view of the display device showing information and aspects of the information that have been highlighted.

FIG. 2 is a cross section of a side view of an embodiment of the display device.

FIG. 3 is a top view of a backlight unit of the backlight system.

FIG. 4 is a top view of a light blocking layer

FIG. 5 is a top view of an information layer, with information to be highlighted, and information not to be highlighted.

FIG. 6 is a cross section of a side view of an alternate embodiment of the display.

FIG. 7 is a top view of an alternate embodiment of a light blocking layer.

FIG. 8 is a top view of an alternate embodiment of the translucent substrate layer.

### DETAILED DESCRIPTION OF THE INVENTION

The inventors have recognized a need in the art for an effective, eye-catching, entertaining and novel way of conveying information using a display that is versatile, easily created, useful for all types of information, and inexpensive. The innovative display device uses a limited number of components but these components can be used in various combinations to tailor the display device to specific requirements. The display device is a self contained unit that presents information, highlights particular points of information with illumination in an informative and entertaining manner, and does so using durable, energy efficient components. On a surface visible to an observer the display device may have information intended to convey a message to the observer, and conveyance of the message may be facilitated by highlighting (e.g. backlighting) one or more aspects of the information. Such highlighting is made possible by a backlight system with its own power source disposed within the display device.

The backlight system is thin and flexible enough to be disposed inside the display device without being obtrusive or overly susceptible to damage. In alternative embodiments, the backlight system may also be rigid depending on the desired usage. The backlight system includes at least one backlight unit and a power source, such as a battery. Each backlight unit includes a light source (or multiple light sources), a waveguide, and a light directing element associated with the waveguide. Due to the unique application of the light directing elements, the display can provide robust amounts of highlighting but require little energy. Together with a waveguide, a light directing element directs more light emitted from a light source, for example a light emitting diode (LED), to the information to be highlighted than does the prior art. Specifically, the LED may direct light into a flexible waveguide. The waveguide takes light from the LED and distributes it throughout the waveguide. In contrast to the prior art, the waveguide area of the instant invention may be small relative to a total area of the display, and as a result less power from the source light (e.g. the LED) is required to produce the required illumination. The light directing elements are associated with a portion of the waveguide where the distributed light is to be directed transversely out of the waveguide. In contrast to the prior art, where the light in the waveguide is not concentrated or directed, the light directing elements essentially concentrate and redirect light present within the waveguide and direct the light toward a chosen region. In the device disclosed herein the chosen region may include information to be highlighted. As a result of the smaller waveguide and concentration of light within the waveguide, the amount of source light required to achieve a desired highlighting effect is much lower in the display device disclosed herein when compared to the prior art. This represents an improvement in the art particularly because these the compact nature of display devices may require that a battery be the power supply for the light source, and the battery will last longer with reduced source light power requirements.

The display device may highlight a single unit of information or may highlight multiple units of information. There may be a single backlight unit or multiple backlight units. The backlight units may each highlight a single or multiple units of information. The backlight system may include a processor that controls power to the backlight unit, and thus controls when the a backlight unit illuminates the information associated with that backlight unit. When a single backlight unit is used, the processor may illuminate the backlight unit according to a predetermined sequence. There may be multiple predetermined sequences, and which sequence is to be used may be based on external factors such as by an external selector or an algorithm that considers factors and decides which to use. When multiple backlight units are used the same applies. For example, a predetermined sequence (pattern) may have different backlight units illuminating in a particular sequence for a preset time, or some or all may be illuminated simultaneously etc. Any pattern or sequence is considered within the scope of this disclosure.

The information to be highlighted may itself be translucent, or may be opaque. The directed light that is highlighting the information may be shaped to match a shape of the unit of information to be highlighted, or may not. In an embodiment where the information to be highlighted is opaque, the light directed to highlight the information may comprise a greater area than the information, and thus the information to be highlighted would be highlighted by a perimeter of light surrounding it.

In order for the device to highlight only certain information when using a waveguide larger than the information to be highlighted the device must be configured to block some light that might otherwise bleed through to an observer. This may be accomplished in any number of ways, including a multi-layer approach or a single layer approach. In a multi layer approach there may be a light blocking layer with openings only where light is to pass through to the information to be highlighted. In a single layer approach all functions may be incorporated on the surface or integral to the single layer. The openings may or may not match a shape of the information to be highlighted. Any combination of functions being incorporated on or within a layer is considered within the scope of the disclosure. Each layer may be a discrete layer of a separate material, or a layer may be applied to another layer to accomplish a purpose. For example, a layer of ink applied to another layer may be a light blocking layer, and/or may contain information. The information may be applied to a top or bottom of a layer, or incorporated with a layer. Any combination is permissible so long as light directed from the waveguide via the light directing elements is effective to highlight the information to be highlighted, but not bleed over, or bleed over minimally into any other area of the display visible to an observer.

The display device may also have a switch that activates the backlight system to highlight the information to be highlighted. The term switch is meant to encompass a wide range of mechanism that activate the desired highlighting. For example, a switch may be a set of electrical contacts that active the backlighting when the contacts touch each other, such as a button. Similarly the switch may be a mechanism that starts the highlighting when the display is opened (if so configured), or is moved, or if a motion sensor detects motion etc. Alternately, the switch may be internal. For example, there may be a timer or processor that initiates the highlighting process according to a timer or in response to any environmental conditions.

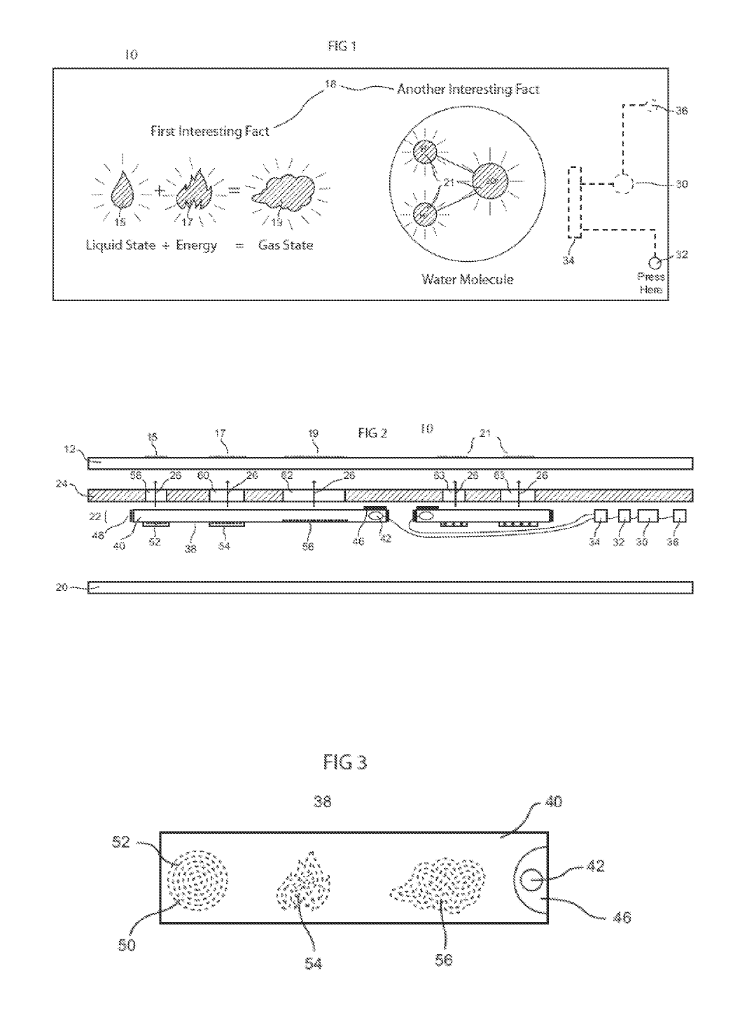

Turning to the drawings, FIG. 1 shows a top view of the display device 10 and FIG. 2 shows a side view of device 10 having a translucent substrate layer 12 having at least one unit of information to be highlighted 15, 17, 19, 21 on it. A unit of information to be highlighted 15, 17, 19, 21 is the information highlighted by a single light director (discussed below). The translucent substrate 12 may also have information not to be highlighted 18 on it. Thus, in an embodiment, the information to be highlighted 15, 17, 19, 21 and any information not to be highlighted 18 are present on the translucent substrate 12. When not highlighted, all the information on the translucent substrate 12 may appear similar, but when highlighted, a unit of information to be highlighted 15, 17, 19, 21 will stand out from the information not to be highlighted 18.

Highlighting can occur in a variety of ways. For example, units of information to be highlighted 15, 17, 19, 21 may all be highlighted simultaneously, or in sequence, or randomly. Units of information to be highlighted 15, 17, 19, 21 may be highlighted in sequence and the sequence may correspond to the order the information is intended to be perceived by the observer. For example, if the display 10 is intended to convey information about a process, the information may show the steps of the process, and the units of information to be highlighted 15, 21, 17, 19, each of which may correspond to a step, could be highlighted in the order the process occurs. Thus, the display breathes life into otherwise dormant information. In an alternative embodiment, the units of information to be highlighted 15, 17, 19, 21 may simply be for entertainment purposes, and be highlighted in a manner that attracts and maintains the observer's attention. Embodiments that mix the two are also envisioned and intended to be within the scope of this disclosure, and the provided examples are not meant to be limiting.

As most easily seen in FIG. 2, there is a structural layer 20, a backlight system 22, a light blocking layer 24, and the translucent layer 12 with units of information to be highlighted 15, 21, 17, 19. The structural layer 20 may be made of any suitable material and may provide structural support for the display. Preferably it will be opaque so no light from the backlight system 22 escapes through it. The backlight system 22 in general terms creates and directs at least one unit of light 26, which passes through the light blocking layer 24 to the translucent layer 12 to highlight the unit of information to be highlighted 15, 21, 17, 19. Thus, the display 10 must be assembled such that the units of light 26 align with respective backing layer holes 58, 60, 62, 63 which in turn align with respective units of information to be highlighted 15, 17, 19, 21. When this is done, the light blocking layer 24 blocks any other light from passing through to the translucent layer 12, thus ensuring that only the light to pass to the translucent layer 12 is that light which highlights as intended.

The backlight system 22 may include a battery 30, a switch 32, a processor 34, a speaker 36, and a backlight unit 38. All of the backlight system 22 components may be electrically connected as necessary to provide an integrated system. Also, the components of the backlight system 22 can be positioned at different locations in the display 10. Each backlight unit 38 may include a waveguide body 40, a waveguide light source 42, at least one light director 52, 54, 56, a waveguide light source blocking cover 46, and a waveguide edge cover 48. The waveguide body 40 distributes the light generated by the waveguide light source 42 throughout the entire waveguide body 40. Preferably, though not necessarily, the waveguide body 40 is made of a flexible material. The waveguide light source blocking cover 46 serves as an additional light blocking element, and the waveguide edge cover 48 serves to prevent light from escaping from the edges of the waveguide body 40. The light director 52, 54, 56 serves to direct light present within the waveguide body 40 out of the waveguide body 40 in a direction transverse to the waveguide body 40. The light director may be any material that accomplishes this known to those in the art, such as patches with shapes/dots within, and may be adhered to the waveguide as depicted by light directors 52, 54. Alternatively, light directors may be integral to the waveguide body 40, such as patterns or markings formed into the waveguide body 40 such as by etching, or other materials formed integral to the waveguide body 40, as evidenced by light director 56.

Each backlight unit 38 may have a single waveguide light source 42, and thus, through use of the processor 34, each backlight unit 38 can be individually illuminated. Each backlight unit 38 may have one or more light directors 52, 54, 56 associated with it.

As a result, when the waveguide light source 42 illuminates a waveguide body 40, as many units of light 26 will be directed from the waveguide 38 as there are light directors 52, 54, 56. For example, if three light directors 52, 54, 56 are associated with a waveguide body 40 of a backlight unit 38, three discrete units of light 26 will be directed from the waveguide body 40. Each of these discrete units of light 26 would be associated with a respective backing layer holes 58, 60, 62 and a respective unit of information to be highlighted 15, 17, 19. Thus, three units of information would be highlighted simultaneously. Such a scenario works when groups of units of information to be highlighted 15, 17, 19 are close enough to each other that a single waveguide body 40 would span them, and all are to be highlighted together. Alternately, a waveguide body 40 of a backlight unit 38 may have a single light director 52, 54, 56 associated with it. This works when a single unit of information is to be highlighted. Combinations of these scenarios are envisioned, such as where a backlight system 22 employs multiple backlight units 38, where some backlight units 38 have a single light director 52, 54, 56 and some backlight units 38 have multiple backlight directors 52, 54, 56, all backlight units 38 have a single light director 52, 54, 56, where all backlight units 38 have multiple backlight directors 52, 54, 56, or any combination thereof.

The backlight system 22 may be powered by a battery 30, and the power may be activated by a switch 32. Once activated by the switch, the processor 34 may control the display in accord with logic associated with the information on the display. The processor 34 may activate (i.e. illuminate) the backlight units in accord with a predetermined pattern, or sequence, where individual backlight units may be illuminated individually, simultaneously, sequentially, or any combination thereof. The predetermined pattern may vary depending on variable the processor 34 may consider and may include information the processor 34 receivers from sensors. For example, if the switch 32 is an accelerometer the processor 34 may determine which pattern to used based on an amount of motion sensed etc. Other sensors not explicitly disclosed herein may also be used. Computer program codes for carrying out operations of certain embodiments of the present invention may be written in an object oriented and/or conventional procedural programming languages including, but not limited to Java, Smalltalk, Perl, Python, Ruby, Lisp, PHP, “C”, FORTRAN, or C++. Certain embodiments of the present invention are described herein with reference to apparatus (systems) and computer program products according to the embodiments of the invention. It will be understood that these program code modules may be provided to a processing module such that the program code modules, which execute via the processor 34, create means for implementing the functions specified. The computer program code modules may also be loaded onto processor 34 to cause a series of operational steps to be performed.

There may be several switches 32, and switches 32 may form part of an interactive experience where the display 10 waits for or response to a press of the button or buttons. This would transform the display 10 from simply an observed device to an interactive device that further engages the observer, thereby making it even more effective at delivering its intended message. Even further, a speaker 36 may be included, such that the display can convey information or effects or instructions to a listener.

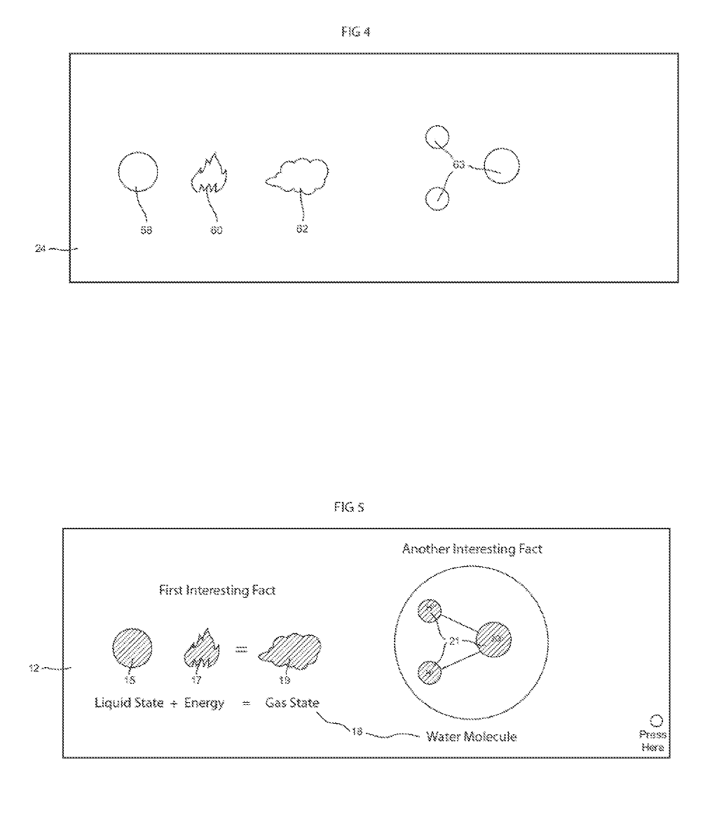

As can be seen in the top view of a backlight unit 38 in FIG. 3, light directors 52, 54, 56 may be associated with the waveguide body 40 at a location 50 on the waveguide body 40 that corresponds to respective backing layer holes 58, 60, 62. The light directors 52, 54, 56 may be, for example, adhered to the waveguide body 40, on either side.

The shape of a cross section of the unit of directed light (hereafter referred to as the shape of the unit of directed light) may be controlled to convey a special message or have a certain effect. For example, it may be advantageous to match the shape of the unit of directed light 26 to the shape of the information to be highlighted 15, 17, 19, 21 so that the backlight effect is limited to only the shape of the information to be highlighted 15, 17, 19, 21. It may be advantageous to shape the unit of directed light 26 for reasons unrelated to the shape of the unit of information 15, 17, 19, 21 to be highlighted as well, such as for dramatic effect or entertainment value. It may also be advantageous for the shape of the unit of directed light to be a general shape, such as a circle, square, oval etc. These and combinations of these variations are envisioned within the scope of this disclosure. The shape of the unit of directed light 26 can be made by shaping the opening in the light blocking layer 58, 60, 62, and using a shaped light director 54 or unshaped light director 52, 56. Using an unshaped light director 52, 56 may simplify assembly, while using a shaped light director 54 may result in a tightly controlled shape of the unit of directed light 26.

As can be seen in FIG. 4, light blocking layer 24 has openings 58, 60, 62, 63 to let the units of directed light 26 through. These openings may not be shaped in any particular relationship to the shape of the information to be highlighted 15, 17, 19, 21 or they may be shaped to match the information to be highlighted 15, 17, 19, 21 or convey an intended message or effect. Various combinations of shaped light directors 54 and unshaped light directors 52, 56 and light blocking layer holes 58, 60, 62 can be seen when the light directors 52, 54, 56 of FIG. 3 are used with the light blocking layer holes 58, 60, 62 of FIG. 4, to highlight units of information to be highlighted 15, 17, 19 of FIG. 1. The shape of the unit of light to highlight the drop of water 15 of FIG. 1 is defined by a light director 52 and light blocking layer hole 58 where neither the shape of the light director 52 nor the shape of the hole in the blocking 58 layer appear to have any direct relationship to the drop of water 15, because the shape of the unit of directed light 26 is circular, while the drop is not. The shape of the unit of light to highlight the fire 17 of FIG. 1 is defined by light director 54, and light blocking layer hole 60, where both are shaped and both shapes match the shape of the unit of information to be highlighted 17. The shape of the unit of light to highlight the gas state 19 of FIG. 1 is defined by light director 56, and light blocking layer hole 62, where the shape of the light director appears to be unrelated to the shape of the unit of information to be highlighted 62, but the light blocking layer opening 62 is shaped its shape matches the shape of the unit of information to be highlighted 17. Thus, the unit of directed light 26 may or may not be shaped, and that shape may or may not match the unit of information to be highlighted 14. FIG. 5 depicts the translucent substrate 12 with information to be highlighted 15, 17, 19, 21 and information not to be highlighted 18.

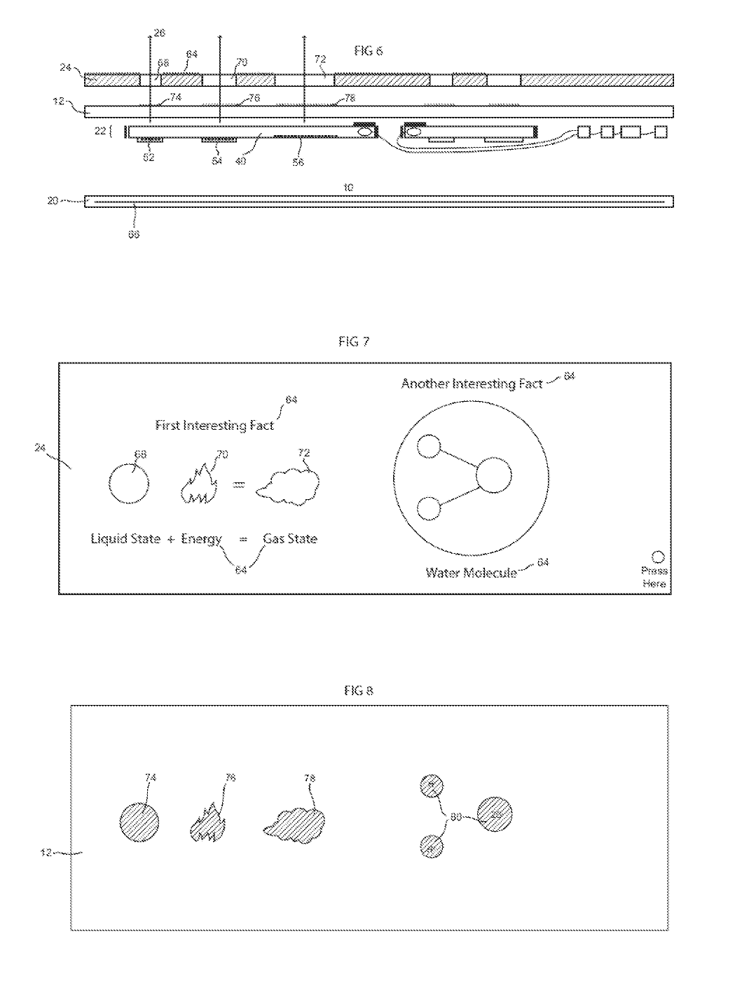

FIG. 6 depicts an embodiment of the display 10 where the translucent layer 12 and the light blocking layer 24 have changed positions relative to the backlight system 22. In this embodiment the units of information to be highlighted 74, 76, 78 remain on the translucent layer 12, but any information not to be highlighted 64 would be present on the light blocking layer 24. Thus, a light director 52, 54, 56 would direct a unit of light transverse 26 to the surface of the waveguide body 40, through the translucent layer 12, into the unit of information to be highlighted 74, 76, 78, through the light blocking layer openings 68, 70, 72, to the observer. As above, the light director 52, 54, 56 must associate with the unit of information to be highlighted 74, 76, 78, which must associate with the light blocking layer hole 68, 70, 72 such that when assembled they align in a manner that enables the unit of directed light 26 to properly highlight the unit of information to be highlighted 74, 76, 78. Further, in all embodiments there may be a pocket 66 in which items can be located. For example, printed information could be placed on the pocket and retrieved as necessary.

As can be seen in FIG. 7, the light blocking layer 24 of this embodiment may have information not intended to be highlighted 64, and light blocking layer openings 68, 70, 72. As can be seen in FIG. 8, the translucent layer 12 may have information to be highlighted 74, 76, 78, 80. As before, a shape of the unit of directed light 26 may be controlled by the shape of the openings in the light blocking layer 68, 70, 72. When the backlight unit 38 of FIG. 3 is used with the units of information to be highlighted 74, 76, 78 of FIG. 8 and the light blocking layer openings 68, 70, 72 of FIG. 7 to produce the display of FIG. 6, the various ways the unit of directed light may be formed can be seen. For example, to highlight the unit of information 74, light director 52 with a shape seemingly unrelated to the shape of the unit of information to be highlighted, i.e. drop 74, is used in conjunction with light blocking layer hole 68, which also has a shape seemingly unrelated to the shape of the unit of information to be highlighted 74. Thus, the shape of the unit of directed light 26 may not match the shape of the unit of information to be highlighted 74. To highlight unit of information to be highlighted 76, a light director 54 with a shape that matches that of the unit of information to be highlighted 76, as well as a light blocking layer hole 70 also with a shape that matches that of the unit of information to be highlighted 76, are used. This would result in a tightly controlled highlighting of the unit of information to be highlighted 70. Finally, to highlight unit of information 78, a light director 56 with a shape seemingly unrelated to the shape of the unit of information to be highlighted 78 is used together with a light blocking layer hole 72 that has a shape that does correspond to a shape of the unit of information to be highlighted 78. As a result the unit of information to be highlighted 78 will also be highlighted with a highlight of a shape that matches the unit of information to be highlighted 78. As above, the unit of directed light 26 may or may not be shaped, and that shape may or may not match the unit of information to be highlighted 74, 76, 78, 80.

Thus, it has been shown that the inventor has innovatively devised a novel display that is inexpensive to create, is versatile, and is effective at conveying information, in a manner not yet known in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A display device, comprising:
one or more layers of material comprising a light transmission region, a unit of information to be highlighted, and a light blocking region;
a backlight unit comprising a planar waveguide body, a light source configured to direct light into the waveguide body, and at least one light director associated with a portion of the waveguide body so as to direct light transversely to a plane of the waveguide body,
wherein the directed light travels through the light transmission region, and wherein the directed light is directed toward the unit of information to be highlighted.

2. The display device of claim 1, comprising a plurality of backlight units, and at least one unit of information to be backlit per backlight unit.

3. The display device of claim 2, comprising a processor configured to control illumination of the backlight units so that the backlight units illuminate according to a predetermined pattern.

4. The display device of claim 3, comprising a sequence activation switch configured to trigger the illumination according to the predetermined pattern.

5. A display device, comprising:
one or more layers of material comprising a light transmission region, a unit of information to be backlit, and a light blocking region;
a backlight unit comprising a planar waveguide body, a light source configured to direct light into the waveguide body, and at least one light director associated with a portion of the waveguide body so as to direct light transversely to a plane of the waveguide body, wherein the directed light travels through the light transmission region, and wherein the directed light is directed toward the unit of information to be highlighted;
a processor comprising a computer program code module that causes the processor to illuminate the backlight unit according to a predetermined pattern.

6. The display device of claim 5, comprising a plurality of backlight units, and at least one unit of information to be highlighted per backlight unit, wherein the computer program module controls illumination of the backlight units according to a predetermined pattern.

7. (canceled)

8. (canceled)

9. A display device, comprising:
a translucent information layer substrate;
information associated with the translucent information layer substrate, comprising at least one unit of information to be highlighted;
a structural layer;
a light blocking layer comprising at least one light blocking layer opening that aligns with the at least one unit of information to be highlighted; and
a backlight system between the structural layer and the light blocking layer comprising at least one backlight unit and a power supply, wherein each backlight unit comprises a flexible, planar waveguide body, a light source mounted on the waveguide body, and at least one light director associated with a portion of the waveguide body so as to direct light transversely to a plane of the waveguide body and toward the at least one light blocking layer opening.

10. The display device of claim 9, wherein the at least one light director is a film attached to a surface of the portion of the waveguide body that aligns with the at least one light blocking layer opening.

11. The display device of claim 9, wherein the at least one light director is integral to the waveguide body and aligns with the at least one light blocking layer opening.

12. The display device of claim 9, wherein a light blocking layer opening shape matches and aligns with a respective shape of the at least one unit of information to be highlighted.

13. The display device of claim 12, wherein a light director shape matches and aligns with the shape of the at least one unit of information to be highlighted.

14. The display device of claim 9, wherein the backlight unit further comprises a light source blocking cover body between the light source and the light blocking layer.

15. The display device of claim 9, wherein the backlight unit further comprises a waveguide edge barrier covering edges of the waveguide body.

16. The display device of claim 9, wherein the backlight system further comprises a switch, wherein activation of the switch activates the light source.

17. The display device of claim 9, comprising a sound emitting device, wherein activation of a switch activates the sound emitting device.

18. The display device of claim 9, comprising a control circuit, wherein activation of a switch activates the control circuit, and wherein the control circuit controls power throughout the display device.

19. The display device of claim 9, wherein the at least one unit of information to be highlighted comprises a plurality of units of information to be highlighted, the light blocking layer comprises a plurality of openings that correspond to respective units of information to be highlighted, and the backlight system comprises a plurality of light directors corresponding to respective portions of the waveguide body that align with the light blocking layer openings.

20. The display device of claim 19, wherein the backlight system comprises a single backlight unit with which all the light directors are associated.

21. The display device of claim 19, wherein the backlight system comprises a plurality of backlight units.

22. The display device of claim 21, comprising a control circuit, wherein the control circuit controls power throughout the display device and illuminates each backlight unit according to a predetermined pattern.

23-40. (canceled)
